(19) United States
(12) Patent Application Publication
(10) Pub. No.: US 2023/0347862 A1
(43) Pub. Date: Nov. 2, 2023

(54) HYBRID ELECTRIC VEHICLE AND DRIVING CONTROL METHOD THEREOF

(71) Applicants: HYUNDAI MOTOR COMPANY, Seoul (KR); KIA CORPORATION, Seoul (KR)

(72) Inventors: Dong Hwan Kwak, Hwaseong-si (KR); Sueng Ho Lee, Seoul (KR); Jeong Mo Jang, Yongin-si (KR)

(73) Assignees: HYUNDAI MOTOR COMPANY, Seoul (KR); KIA CORPORATION, Seoul (KR)

(21) Appl. No.: 17/949,825

(22) Filed: Sep. 21, 2022

(30) Foreign Application Priority Data
Apr. 28, 2022 (KR) 10-2022-0052854

(51) Int. Cl. B60W 20/10; B60W 10/08; B60W 10/06; F02D 41/00

(52) U.S. Cl. CPC B60W 20/10; B60W 10/08; B60W 10/06; F02D 41/009; B60W 2510/0685; B60W 2510/08; B60W 2710/0644; B60W 2710/081; B60W 2510/0638

(57) ABSTRACT

A hybrid electric vehicle includes: a motor equipped with a resolver for detecting a first rotation angle; an engine connected to the motor; a motor controller configured to control the motor and to generate virtual angle sensor information of the engine based on the first rotation angle; and an engine controller configured to control the engine based on the generated virtual angle sensor information. The virtual angle sensor information includes at least one of a second rotation angle that is a crank angle of the engine and information on crank top dead center.

### CROSS REFERENCE TO RELATED APPLICATION

The present application claims priority to Korean Patent Application No. 10-2022-0052854, filed Apr. 28, 2022, the entire contents of which are incorporated herein for all purposes by this reference.

### BACKGROUND

### Field of the Disclosure

The present disclosure relates to a hybrid electric vehicle capable of maintaining vehicle stability and performance by replacing a crank angle sensor of an engine with a virtual crank angle sensor. The present disclosure further relates to a driving control method thereof.

### Description of the Related Art

Eco-friendly vehicles such as pure electric vehicles, hybrid electric vehicles, and fuel cell vehicles that can replace internal combustion engine vehicles are also called electrification vehicles. Such vehicles are called electrification vehicles because eco-friendly vehicles employ an electric motor as a driving source for driving the vehicles. Among them, a hybrid electric vehicle includes both an engine and a motor. Thus, a hybrid electric vehicle requires detection of a rotation angle for the drive control of the engine and the motor.

A resolver is used as a position sensor for detecting the absolute angular position of a rotor of a motor. The resolver has high mechanical strength and superior durability compared to an encoder. Thus, the resolver can be used as a position sensor for a drive motor in fields, such as electric vehicles, that require high performance and high precision driving.

On the other hand, in the case of the engine, if the rotation angle is not detected, the position of a crankshaft (e.g., top dead center) cannot be measured. Thus, a problem arises in that the fuel injection amount, injection timing, and ignition timing of the engine cannot be accurately determined.

Accordingly, even when a crank angle sensor for detecting the engine rotation angle is not provided in a hybrid electric vehicle, a method for detecting the engine rotation angle is required in order to enable the engine to start in the same manner as in the existing system.

The foregoing is intended merely to aid in understanding the background of the present disclosure. The foregoing is not intended to mean that the present disclosure falls within the purview of the related art that is already known to those having ordinary skill in the art.

### SUMMARY

Accordingly, the present disclosure has been made keeping in mind the above problems occurring in the related art. An objective of the present disclosure is to provide a hybrid electric vehicle where a structure in which an engine and a motor are directly connected. A further object of the present disclosure is to provide a hybrid electric vehicle where the current rotation angle of the engine is determined based on a rotation angle of the motor detected by a resolver of the motor. Another object of the present disclosure is to provide a hybrid electric vehicle where a crank angle sensor of the engine is replaced by a virtual crank angle sensor, which enables vehicle stability and performance to be maintained. A further object of the present disclosure is to provide a driving control method thereof.

The technical problems to be addressed in the present disclosure are not limited to the technical problems mentioned above. Other technical problems not mentioned should be clearly understood by those having ordinary skill in the art to which the present disclosure belongs from the description below.

In order to accomplish the above objectives, according to an aspect of the present disclosure, a hybrid electric vehicle is provided. The hybrid electric vehicle includes a motor equipped with a resolver for detecting a first rotation angle and includes an engine connected to the motor. The hybrid electric vehicle further includes a motor controller configured to control the motor and to generate virtual angle sensor information of the engine based on the first rotation angle. Furthermore, the hybrid electric vehicle includes an engine controller configured to control the engine based on the generated virtual angle sensor information. The virtual angle sensor information includes at least one of a second rotation angle that is a crank angle of the engine and information on crank top dead center.

The motor controller may determine the second rotation angle based on a rotation ratio of the engine and the motor and the first rotation angle.

The engine may further include a cam angle sensor for measuring a revolutions per minute (RPM) of the engine. The rotation ratio of the engine and the motor may be corrected by using a result of comparing RPMs of the engine and the motor measured by the cam angle sensor.

The relationship between the rotation ratio of the engine and the motor, the first rotation angle, and the second rotation angle may be obtained by Equation 1 below:

θ₂=kθ₁ Equation 1:

In Equation 1, θ₁=variation in first rotation angle, θ₂=variation in second rotation angle, and k=rotation ratio of engine and motor.

The motor may be directly connected to the engine.

The motor controller may simulate the crank top dead center in the form of a missing tooth signal.

The motor controller may determine the crank top dead center information based on a pre-stored offset corresponding to the first rotation angle at the crank top dead center, an RPM of the motor, and the rotation ratio of the engine and the motor.

The pre-stored offset may include a first offset set during initial assembly or maintenance and a second offset determined based on the RPM of the motor and the first rotation angle stored at a time when the engine is finally stopped.

The relationship between the pre-stored offset corresponding to the first rotation angle at the crank top dead center, the RPM of the motor, and the rotation ratio of the engine and the motor may be obtained by Equation 2 below:

θ₁=a+2πkn Equation 2:

In Equation 2, 01=the first rotation angle of the motor, a=the pre-stored offset corresponding to the first rotation angle at the crank top dead center, k=the rotation ratio of the engine and the motor, and n=the RPM of the motor, however, a value that is obtained by subtracting the RPM of the motor upon measuring the first rotation angle from the final RPM of the motor.

The motor controller may store the final motor RPM and the motor resolver position when the engine is stopped after driving.

According to another aspect of the present disclosure, a method of controlling driving of a hybrid electric vehicle is provided. The method includes detecting, by a motor resolver, a first rotation angle of a motor. The method further includes generating, by a motor controller, virtual angle sensor information of an engine based on the detected first rotation angle of the motor. The method also includes controlling, by an engine controller, the engine based on the generated virtual angle sensor information. The virtual angle sensor information includes at least one of a second rotation angle that is a crank angle of the engine and information on crank top dead center.

The method may further include correcting an engine-motor rotation ratio by using a result of comparing RPMs between the engine and the motor measured by a cam angle sensor.

The method may further include storing, by the motor controller, a final motor RPM and a motor resolver position when the engine is stopped after driving.

The method may further include, after storing the final motor RPM and the motor resolver position, generating, by the motor controller, virtual angle sensor information of the engine again based on the final motor RPM and the motor resolver position.

The motor controller may determine the crank top dead center information based on a pre-stored offset corresponding to the first rotation angle at the crank top dead center, an RPM of the motor, and a rotation ratio of the engine and the motor.

The pre-stored offset may include a first offset set during initial assembly or during maintenance and a second offset determined based on the RPM of the motor and the first rotation angle stored at a time when the engine is finally stopped.

According to the hybrid electric vehicle and the driving control method thereof, in a structure in which the engine and the motor are directly connected, the current rotation angle of the engine is determined based on the rotation angle of the motor detected by the motor resolver. The crank angle sensor of the engine is replaced by the virtual crank angle sensor, which enables vehicle stability and performance to be maintained and implements the present disclosure without an additional increase in cost through the improvement of the software control logic.

It should be appreciated by those having ordinary skill in the art that the effects that can be achieved with the present disclosure are not limited to those described above. Other advantages of the present disclosure should be clearly understood from the following detailed description.

### BRIEF DESCRIPTION OF THE DRAWINGS

FIG. 1 illustrates an example of a configuration of a power train in a hybrid electric vehicle according to an embodiment of the present disclosure;

FIG. 2 illustrates an example of a configuration of a control system in a hybrid electric vehicle according to an embodiment of the present disclosure;

FIG. 3 illustrates an example of a second rotation angle detection method when an engine crank is located at top dead center through simulating a missing tooth recognition signal for the crank top dead center of a motor controller;

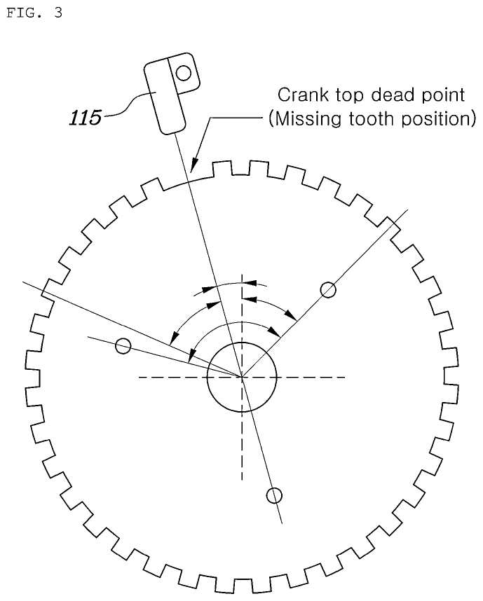

FIG. 4 illustrates a graph in which the missing tooth recognition signal of the motor controller, according to FIG. 3, is simulated;

FIG. 5 is a graph illustrating a first rotation angle recognition signal of a motor through a resolver; and

FIG. 6 is a flowchart illustrating a driving control method of a hybrid electric vehicle according to the present disclosure.

### DETAILED DESCRIPTION

Hereinafter, embodiments disclosed in the present specification are described in detail with reference to the accompanying drawings. The same or similar components are assigned the same reference numbers and a redundant description thereof has been omitted. The suffixes “module” and “part” for the components used in the following description are given or interchanged in consideration of only the ease of constructing the specification, and do not have distinct meanings or functions by themselves. In addition, in describing the embodiments disclosed in the present specification, if it is determined that detailed descriptions of related known technologies may obscure the gist of the embodiments disclosed in the present specification, the detailed description thereof has been omitted. In addition, the accompanying drawings are only to help understand the embodiments disclosed in the present specification. Thus, the technical spirit of the inventive concepts disclosed herein is not limited by the accompanying drawings. The accompanying drawings should be understood as covering all changes, equivalents, or substitutes included in the spirit and scope of the present disclosure.

It should be understood that, although the terms “first”, “second”, and the like, may be used herein to describe various elements, these elements should not be limited by these terms. These terms are only used to distinguish one element from another element.

It should be understood that, when an element is referred to as being “connected” or “coupled” to another element, it can be directly connected or coupled to the other element or intervening elements may be present therebetween. In contrast, it should be understood that when an element is referred to as being “directly connected” to another element, there are no intervening elements present.

As used herein, the singular forms “a”, “an”, and “the” are intended to include the plural forms as well, unless the context clearly indicates otherwise.

It should be further understood that the terms “comprises” and/or “comprising”, or “includes” and/or “including”, when used in the specification, specify the presence of stated features, integers, steps, operations, elements, components, or combinations thereof. Such terms do not preclude the presence or addition of one or more other features, integers, steps, operations, elements, components, or combinations thereof.

In addition, a unit or control unit included in the names of a motor control unit (MCU), a hybrid control unit (HCU), and the like, is only a term widely used in the naming of a controller that controls a specific vehicle function, and does not mean a generic function unit. For example, a respective controller may include a communication device that communicates with other controllers or sensors to control its own function, a memory that stores an operating system or logic command and input/output information, and one or more processors that perform judgement, operation, and determination necessary for controlling their own functions. When a component, device, element, or the like of the present disclosure is described as having a purpose or performing an operation, function, or the like, the component, device, or element should be considered herein as being “configured to” meet that purpose or to perform that operation or function.

Prior to describing a control method of a hybrid electric vehicle according to embodiments of the present disclosure, a structure and a control system of a hybrid electric vehicle applicable to the embodiments are first described.

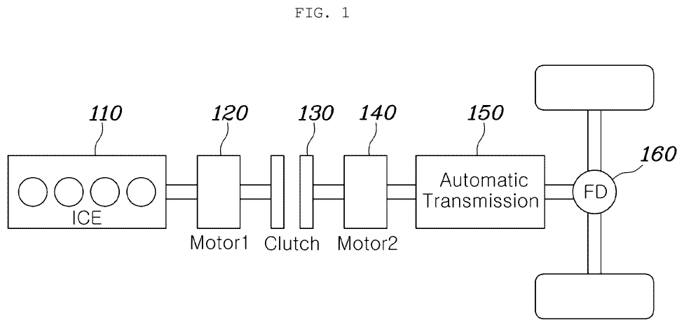

FIG. 1 illustrates an example of a configuration of a power train in a hybrid electric vehicle according to an embodiment of the present disclosure.

Referring to FIG. 1, a power train of a hybrid electric vehicle employing a parallel type hybrid system in which two motors, i.e., a first motor 120 and a second motor 140, and an engine clutch 130 are mounted between an internal combustion engine (ICE) or engine 110 and a transmission 150 is illustrated. Such a parallel hybrid system is also called a transmission mounted electric drive (TMED) hybrid system because the second motor 140 is always connected to an input stage of the transmission 150.

In the two motors 120 and 140, the first motor 120 is disposed between the engine 110 and one side of the engine clutch 130. An engine shaft of the engine 110 and a first motor shaft of the first motor 120 are directly connected to each other so that the engine shaft and the motor shaft can rotate together at all times.

One side of a second motor shaft of the second motor 140 may be connected to the other side of the engine clutch 130. The other side of the second motor shaft may be connected to the input stage of the transmission 150.

The second motor 140 may have a greater output than the first motor 120, so the second motor 140 may serve as a driving motor. In addition, the first motor 120 may function as a starting motor for cranking the engine 110 when the engine 110 is started. The first motor 120 may recover rotational energy of the engine 110 through power generation upon stopping the engine 110. Further, the first motor 120 may perform power generation with the power of the engine 110 during the operation of the engine 110.

When a driver steps on an accelerator pedal after starting a hybrid electric vehicle (e.g., HEV Ready or HEV mode), having a power train as illustrated in FIG. 1, the second motor 140 is driven using the power of a battery (not shown) in a state in which the engine clutch 130 is opened. Accordingly, wheels are activated while the power of the second motor 140 is transmitted through the transmission 150 and a final drive (FD) 160 (i.e., the electric vehicle (EV) mode). When a vehicle is gradually accelerated so a greater driving force is required, the first motor 120 may operate to crank the engine 110.

When the difference in rotational speed between the engine 110 and the second motor 140 is within a predetermined range after the engine 110 is started, the engine clutch 130 is engaged between the engine 110 and the second motor 140 so that the engine 110 and the second motor 140 rotate together (i.e., switching from EV mode to HEV mode). Accordingly, through the torque blending process, the output of the second motor 140 is lowered and the output of the engine 110 is increased, thereby satisfying the driver's required torque. In the HEV mode, the engine 110 may satisfy most of the required torque and the difference between the engine torque and the required torque may be compensated through at least one of the first motor 120 and the second motor 140. For example, when the engine 110 outputs a torque higher than the required torque in consideration of the efficiency of the engine 110, the first motor 120 or the second motor 140 generates power by the engine torque surplus. When the engine torque is less than the required torque, at least one of the first motor 120 and the second motor 140 may output the insufficient torque.

When a preset engine off condition, as in vehicle deceleration, or the like, is satisfied, the engine clutch 130 is opened and the engine 110 is stopped (i.e., switching from the HEV mode to the EV mode). During deceleration, the battery is charged through the second motor 140 using the driving force of the wheels, which is called braking energy regeneration or regenerative braking.

In general, the transmission 150 may be a stepped transmission or a multi-plate clutch, for example, a dual-clutch transmission (DCT).

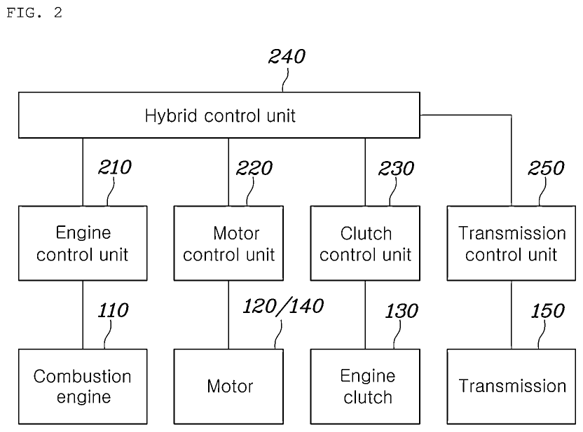

FIG. 2 illustrates an example of a configuration of a control system in a hybrid electric vehicle according to an embodiment of the present invention.

Referring to FIG. 2, in a hybrid electric vehicle to which embodiments of the present disclosure can be applied, the internal combustion engine 110 may be controlled by an engine controller 210. The first motor 120 and the second motor 140 may also be torque-controlled by a motor controller (MCU) 220 and the engine clutch 130 may be controlled by a clutch controller 230.

Here, the engine controller 210 is also called an engine management system (EMS). The engine controller 210 may use the virtual angle sensor information of the engine generated through the motor controller 220 in determining the fuel injection amount, injection timing, and ignition timing of the engine 110.

In addition, the transmission 150 is controlled by a transmission controller 250.

The motor controller 220 may control a gate drive unit (not shown) with a pulse width modulation (PWM) control signal based on a motor angle, a phase voltage, a phase current, and the required torque of each motor 120 or 140. Accordingly, the gate drive unit may control an inverter (not shown) that drives each of the motors 120 and 140. The motor controller 220 may acquire motor angle (or rotation angle) information through a resolver (not shown) provided in each of the motors 120 and 140.

Each controller may be connected to a hybrid controller (or hybrid control unit (HCU)) 240 as its upper controller that controls the overall power train including the mode switching process to provide information about engine clutch control and/or information about engine stop control. The information is required during drive mode switching or gear shifting under the control of the hybrid controller 240. The information is provided to the hybrid controller 240 or to perform an operation according to a control signal.

For example, the hybrid controller 240 determines whether to perform switching between EV-HEV modes or CD-CS modes (in the case of a plug-in hybrid electric vehicle (PHEV)) according to a vehicle driving state. To this end, the hybrid controller determines disengaging (opening) timing of the engine clutch 130 and performs hydraulic control during disengagement. In addition, the hybrid controller 240 may determine the state (Lock-up, Slip, Open, and the like) of the engine clutch 130 and control the timing of stopping the fuel injection of the engine 110. Also, the hybrid controller may transmit a torque command for controlling the torque of the first motor 120 to the motor controller 220 for engine stop control to control engine rotational energy recovery. In addition, the hybrid controller 240 may determine the state of each of the drive sources, i.e., the engine 110, first motor 120, and second motor 140 and thus determine the required drive force to be shared by respective drive sources 110, 120, and 140. The hybrid controller 240 may also transmit a torque command to the controllers 210 and 220 for controlling the respective drive sources in order to satisfy the required torque.

Of course, it should be apparent to those having ordinary skill in the art that the above-described connection relationship between the controllers and the function/classification of respective controllers are examples and are not limited by their names. For example, the hybrid controller 240 may be implemented such that the corresponding function is replaced and provided in any one of the other controllers, or the corresponding function may be distributed and provided in two or more of the other controllers.

The configurations of FIGS. 1 and 2 described above are only one example of a hybrid electric vehicle, and the hybrid electric vehicle applicable to the embodiment is not limited to this structure. For example, although it is assumed that the first motor 120 and the engine 110 are directly connected to each other in FIG. 1, according to another implementation, the first motor 120 and the engine 110 may be connected by means of a predetermined connection means such as a pulley and a belt.

In an embodiment of the present disclosure, logic for determining the current rotation angle of the engine 110 is proposed. The logic is implemented by a virtual engine crank sensor through the resolver of the first motor 120 connected to the engine 110 so as to replace the crank sensor of the engine 110 that detects the rotation angle of the engine 110 in a hybrid electric vehicle.

In the following description, for convenience, the rotation angle of the first motor 120 detected by the resolver is called a first rotation angle. The rotation angle of the engine 110 detected by the virtual angle sensor implemented through the motor controller is called a second rotation angle.

The engine controller 210 may determine the fuel injection amount, fuel injection timing, ignition timing, and the like of the engine 110 based on the second rotation angle when the engine crank is positioned at top dead center. Top dead center is a position of a piston when the piston is closest to a cylinder head in a cylinder and means a point at which the piston in a multi-cylinder engine, such as the engine 110, rises to the highest level or point.

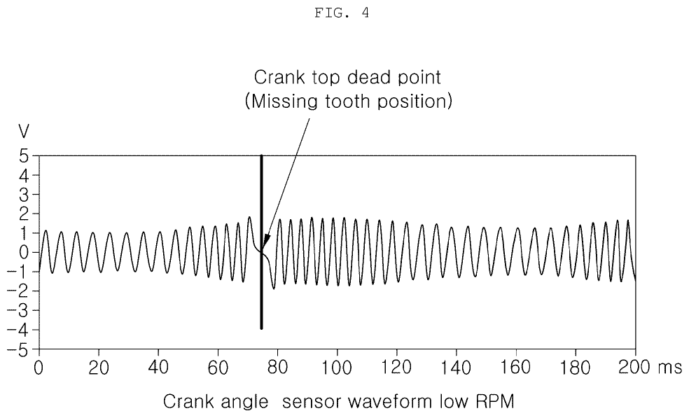

The angle sensor virtually implemented by the motor controller 220 may detect a rotation angle of the engine 110 and output a corresponding signal. For example, the motor controller 220 may detect a rotation angle of the engine 110 when the engine crank is positioned at top dead center and outputs a missing tooth recognition signal type. Specifically, the angle sensor virtually implemented by the motor controller 220 has a discontinuous waveform as illustrated in FIG. 4 at a point corresponding to a missing tooth. Accordingly, the engine controller 210 may determine the point at which the discontinuous waveform is detected as the missing tooth recognition point.

Hereinafter, the motor controller 220 is described. The motor controller 220 determines the second rotation angle based on the rotation ratio of the engine 110 and the motor and the first rotation angle.

The relationship between the rotation ratio of the engine and the motor, the first rotation angle, and the second rotation angle may be obtained by Equation 1 below:

θ₂=kθ₁ Equation 1:

In Equation 1, θ₁=variation in first rotation angle, θ₂=variation in second rotation angle, and k=rotation ratio of engine and motor.

Referring to Equation 1, when the rotation ratio of the engine 110 and the first motor 120 is not 1, the relationship between the first rotational angle variation and the second rotational angle variation may be expressed by the following Equation: θ₂=kθ₁ (k≠1). For example, in a structure in which the first motor 120 and the engine 110 are connected through a pulley and a belt, rather than a structure in which the first motor 120 and the engine 110 are directly connected, the rotation ratio of the motor and the engine 110 will not be 1. On the other hand, when the first motor 120 is directly connected to the engine 110 through the crankshaft thereof, the rotation ratio of the first motor 120 and the engine 110 by the connecting means becomes 1, so that θ₂=θ₁ is established.

In order for the motor controller 220 to accurately implement the crank angle sensor, the rotation ratio of the engine 110 and the first motor 120 needs to be accurate. However, due to the assembly tolerance between the engine 110 and the first motor 120, a problem occurs in that the rotation ratio of the engine and the motor may not be accurate. More specifically, when assembling the engine 110 and the first motor 120, the rotation ratio of the engine 110 and the first motor 120 has a significant number of decimal places, i.e., about 3 decimal places. However, the revolutions per minute (RPM) of the engine 110 is approximately 4000 RPM. Thus, the engine rotates 240,000 times during a 1 hour driving period which renders the rotation ratio of the engine 110 and the first motor 120, having significant digits of about 3 decimal places, to generate a large error in estimating the angle of the crank angle sensor. Accordingly, it is required for the motor controller 220 to generate accurate virtual angle sensor information of the engine 110 by correcting the rotation ratio of the engine 110 and the first motor 120.

In order to correct the rotation ratio of the engine 110 and the first motor 120, the RPM of the engine 110 and the RPM of the first motor 120 should first be measured. In this case, the engine 110 includes a cam and a crank, and although the crank angle sensor is omitted in the embodiments of the present disclosure, the cam may include an angle sensor. The cam angle sensor may measure the RPM of the engine 110, and the cam angle sensor may also be called a cam position sensor. The cam angle sensor can estimate the position of the cam and the position of top dead center and bottom dead center of the crank of the engine 110, so that the cam angle sensor can be used to assist the crank angle sensor.

However, the cam position estimation function of the cam angle sensor uses various techniques, for example, shortening the fuel injection timing of the engine 110 or increasing or decreasing the injection time through fine adjustment of the cam position. Such various techniques are used so that, although it is often the case in which the angle of the crank angle sensor and the angle of the cam angle sensor may not exactly match each other, the RPM of the engine 110 may still be measured by measuring the RPM of the cam angle sensor.

Therefore, when assembling the engine 110 and the first motor 120, the rotation ratio of the engine 110 and the first motor 120 is only referred to as an initial value. Further, through the comparison result between the engine 110 RPM measured through the cam angle sensor and the first motor 120 RPM measured through the resolver of the engine 110, the actual rotation ratio of the engine 110 and the first motor 120 can be corrected with high precision.

On the other hand, if the pre-stored offset corresponding to the first rotation angle at crank top dead center can be known, the first rotation angle after n turns of the first motor 120, at which the crank is at top dead center, can be known by Equation 2 below:

θ₁=a+2πkn Equation 2:

In Equation 2, θ₁=the first rotation angle of the motor, a=the pre-stored offset corresponding to the first rotation angle at the crank top dead center, k=the rotation ratio of the engine and the motor, and n=the RPM of the motor, however, a value that is obtained by subtracting the RPM of the motor upon measuring the first rotation angle from the final RPM of the motor)

Referring to Equation 2, if the relationship between the first rotation angle of the first motor 120 and the RPM of the first motor 120 is expressed in a radian unit system, the first rotation angle θ1, corresponding to crank top dead center position after n turns of the first motor 120, can be obtained by adding a value obtained by multiplying the rotation ratio of the first motor 120 and the engine 110. The engine 110 is connected by the connection means by the rotation angle (grin) of the first motor 120 according to the RPM of the first motor 120 to the initially-stored offset (a) corresponding to the first rotation angle at the crank top dead center.

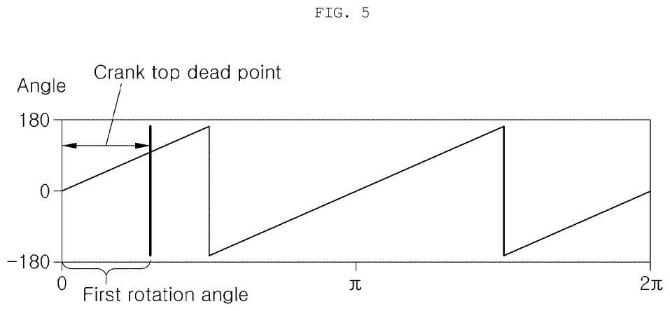

When Equations 1 and 2 are applied to the hybrid electric vehicle shown in FIG. 1, the first motor 120 and the engine 110 are directly connected, thereby k=1. Equation 1 may be expressed as ‘θ₂=θ₁’, and Equation 2 may be expressed as ‘θ₁=a’. The relationship between the resolver signal and the crank top dead center is as illustrated in FIG. 5.

FIG. 5 is a graph illustrating a first rotation angle recognition signal of a first motor 120 through a resolver. Since the engine 110 and the first motor 120 are directly connected, the second rotation angle at the missing tooth recognition point, i.e., at the crank top dead center, in FIG. 4 matches the specific first rotation angle detected through the resolver.

The pre-stored offset may include both a first offset and a second offset. The first offset may mean an offset in a state initialized from crank top dead center during initial assembly or maintenance. The second offset may mean an offset at the crank top dead center determined based on the RPM of the first motor 120 and the first rotation angle stored at the time when the engine 110 is finally stopped.

A description is now made of a specific method of determining, by the motor controller 220, the first rotation angle of the first motor 120, where the crank sensor of the engine 110 is not provided, based on the relationship between the first and second rotation angles and the RPMs described above. For the convenience of explanation, it is assumed that ‘k=1’.

First, upon initial starting of a vehicle, an RPM of the first motor 120 is 0, the first rotation angle of the first motor 120 is 0 degrees, and an RPM of the engine 110 is 0. After driving a certain distance, the RPM (n) of the first motor 120 indicates 50 million, and the first rotation angle θ₁ of the first motor 120 indicates 25 degrees. The engine 110 has rotated 50 million times, and the current second rotation angle θ₂ of the engine 110 is 25 degrees according to the Equation of ‘θ₂=θ₁=a+2πkn’.

Second, upon initial starting of the vehicle, the RPM of the first motor 120 is 0, and the crank is positioned at top dead center when the first rotation angle of the first motor 120 is degrees. Therefore, the pre-stored offset (a) corresponding to the first rotation angle at crank top dead center becomes 15 degrees. When the RPM (n) of the first motor 120 is 5000 after driving a certain distance, the engine 110 becomes the crank top dead center when the first rotation angle θ₁ of the first motor 120 is 15 degrees, according to the Equation of ‘θ₁=a+2πkn’.

Third, it is assumed that according to the structure in which the first motor 120 and the engine 110 are connected through a pulley and a belt, rather than a structure in which the first motor 120 and the engine 110 are directly connected, the relationship between the first rotation angle and the second rotation angle is ‘θ₂=kθ₁’ and (k=1.12). Upon initial starting of a vehicle, the RPM of the first motor 120 is 0, and the crank is positioned at top dead center when the first rotation angle of the first motor 120 is 15 degrees. Therefore, the pre-stored offset (a) corresponding to the first rotation angle at crank top dead center becomes 15 degrees. If the RPM (n) of the first motor 120 is 5000 after driving a certain distance, the engine 110 becomes the crank top dead center when a=15, k=1.12, n=5000, and θ₁=15 degrees, according to the Equation of ‘θ₁=a+2πkn’. In the same way, when the RPM of the first motor 120 is 5001, the point at which the first rotation angle (θ₁) of the first motor 120=42.2 degrees is calculated as the next top dead center.

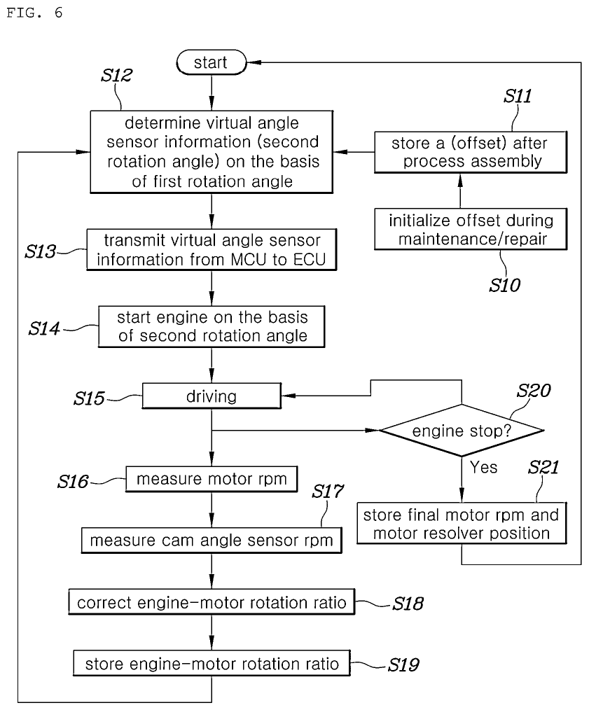

The above-described method of generating, by the motor controller 220, virtual angle sensor information is summarized in a flowchart as shown in FIG. 6.

FIG. 6 is a flowchart illustrating a driving control method of a hybrid electric vehicle according to the present disclosure.

Referring to FIG. 6, a flowchart is shown according to the logic that can determine the current rotation angle of the engine 110. The logic implements the virtual crank sensor of the engine 110 through the resolver of the first motor 120 connected to the engine 110 to replace the crank sensor of the engine 110 that detects the rotation angle of the engine 110 in a hybrid electric vehicle.

First, upon initial assembly or maintenance of the engine 110 and the first motor 120, an offset corresponding to the first rotation angle at crank top dead center may be initialized (S10). Then, the motor controller 220 stores the offset set during assembly or maintenance (S11).

The motor controller 220 may generate virtual angle sensor information of the engine 110 based on the first rotation angle of the first motor 120 (S12). Subsequently, the motor controller 220 may transmit the generated virtual angle sensor information of the engine 110 to the engine controller 210 (S13).

The motor controller 220 may generate virtual angle sensor information including a pre-stored offset and an RPM of the first motor 120, and including the RPM of the first motor 120 and the corrected rotation ratio of the engine 110 and the first motor 120.

The pre-stored offset includes a first offset set during initial assembly or maintenance and a second offset determined based on the RPM of the first motor 120 and the first rotation angle stored at the time when the engine 110 is finally stopped. The offset is an example and is not necessarily limited thereto.

As described above, the relationship between the rotation ratio of the engine 110 and the first motor 120, the first rotation angle, and the second rotation angle may be known with reference to Equation 1. If the pre-stored offset corresponding to the first rotation angle at crank top dead center can be known, the first rotation angle after n turns of the first motor 120, at which the crank is at top dead center, can be known by Equation 2. Similarly, when Equations 1 and 2 are applied to a hybrid electric vehicle, as shown in FIG. 1, it is assumed that the first motor 120 and the engine 110 are directly connected, thereby k=1.

After the motor controller 220 transmits the virtual angle sensor information to the engine controller 210 (S13), the engine controller 210 may control starting of the engine 110 based on the determined second rotation angle of the engine 110 (S14) so that the vehicle can be driven (S15).

When driving has started through the engine controller 210 (S15), an RPM of the engine 110, which is measured through a cam angle sensor, and an RPM of the first motor 120, which is measured through the resolver, are compared. Further, based on the comparison result, the actual rotation ratio of the engine 110 and the first motor 120 can be corrected with high precision (S16-S18). Thereafter, the motor controller 220 may store the corrected actual rotation ratio of the engine 110 and the first motor 120 (S19).

Thereafter, when the engine 110 is stopped (YES in S20), the motor controller 220 may store the final RPM of the first motor 120 and the position of the motor resolver to determine the first rotation angle corresponding to the next top dead center (S21). The motor controller 220 may then generate the virtual angle sensor information of the engine 110 again based on the stored final first motor 120 RPM and the motor resolver position.

The present disclosure described above can be implemented as computer-readable codes on a medium in which a program is recorded. The computer-readable medium includes all types of recording devices in which data readable by a computer system is stored. Examples of computer-readable media include Hard Disk Drive (HDD), Solid State Disk (SSD), Silicon Disk Drive (SDD), ROM, RAM, compact disc-ROM (CD-ROM), magnetic tape, floppy disk, optical data storage device, and the like. Accordingly, the above detailed description should not be construed as restrictive in all respects, but as being described only by way of example.

The scope of the present disclosure should be determined by a reasonable interpretation of the appended claims. All modifications within the equivalent scope of the present disclosure are included in the scope of the present disclosure.

What is claimed is:

1. A hybrid electric vehicle comprising:
a motor equipped with a resolver for detecting a first rotation angle;
an engine connected to the motor;
a motor controller configured to control the motor and to generate virtual angle sensor information of the engine based on the first rotation angle; and
an engine controller configured to control the engine based on the generated virtual angle sensor information,
wherein the virtual angle sensor information includes at least one of a second rotation angle that is a crank angle of the engine and information on crank top dead center.

2. The hybrid electric vehicle according to claim 1, wherein the motor controller determines the second rotation angle based on a rotation ratio of the engine and the motor, and the first rotation angle.

3. The hybrid electric vehicle according to claim 2, wherein the engine further comprises a cam angle sensor for measuring a revolutions per minute (RPM) of the engine, and wherein the rotation ratio of the engine and the motor is corrected by using a result of comparing RPMs of the engine and the motor measured by the cam angle sensor.

4. The hybrid electric vehicle according to claim 2, wherein a relationship between the rotation ratio of the engine and the motor, the first rotation angle, and the second rotation angle is obtained by Equation 1 below:
θ₂=kθ₁ Equation 1:
wherein θ₁=variation in first rotation angle, θ₂=variation in second rotation angle, and k=rotation ratio of engine and motor.

5. The hybrid electric vehicle according to claim 1, wherein the motor is directly connected to the engine.

6. The hybrid electric vehicle according to claim 1, wherein the motor controller simulates the crank top dead center in a form of a missing tooth signal.

7. The hybrid electric vehicle according to claim 1, wherein the motor controller determines the crank top dead center information based on a pre-stored offset corresponding to the first rotation angle at the crank top dead center, an RPM of the motor, and a rotation ratio of the engine and the motor.

8. The hybrid electric vehicle according to claim 7, wherein the pre-stored offset includes a first offset set during initial assembly or during maintenance and a second offset determined based on the RPM of the motor and the first rotation angle stored at a time when the engine is finally stopped.

9. The hybrid electric vehicle according to claim 7, wherein a relationship between the pre-stored offset corresponding to the first rotation angle at the crank top dead center, the RPM of the motor, and the rotation ratio of the engine and the motor is obtained by Equation 2 below:
θ₁=a+2πkn Equation 2:
wherein θ₁=the first rotation angle of the motor, a=the pre-stored offset corresponding to the first rotation angle at the crank top dead center, k=the rotation ratio of the engine and the motor, and n=the RPM of the motor, however, a value that is obtained by subtracting the RPM of the motor upon measuring the first rotation angle from a final RPM of the motor.

10. The hybrid electric vehicle according to claim 1, wherein the motor controller stores a final motor RPM and the motor resolver position when the engine is stopped after driving.

11. A method of controlling driving of a hybrid electric vehicle, the method comprising:
detecting, by a motor resolver, a first rotation angle of a motor;
generating, by a motor controller, virtual angle sensor information of an engine based on the detected first rotation angle of the motor; and
controlling, by an engine controller, the engine based on the generated virtual angle sensor information,
wherein the virtual angle sensor information includes at least one of a second rotation angle that is a crank angle of the engine and information on crank top dead center.

12. The method according to claim 11, further comprising:
correcting an engine-motor rotation ratio by using a result of comparing RPMs between the engine and the motor measured by a cam angle sensor.

13. The method according to claim 11, further comprising;
storing, by the motor controller, a final motor RPM and a motor resolver position when the engine is stopped after driving.

14. The method according to claim 13, further comprising:
after storing the final motor RPM and the motor resolver position, generating, by the motor controller, virtual angle sensor information of the engine again based on the final motor RPM and the motor resolver position.

15. The method according to claim 11, wherein the motor controller determines the crank top dead center information based on a pre-stored offset corresponding to the first rotation angle at the crank top dead center, an RPM of the motor, and a rotation ratio of the engine and the motor.

16. The method according to claim 15, wherein the pre-stored offset includes a first offset set during initial assembly or during maintenance and a second offset determined based on the RPM of the motor and the first rotation angle stored at a time when the engine is finally stopped.
